(19) United States
(12) Patent Application Publication
(10) Pub. No.: US 2026/0225969 A1
(43) Pub. Date: Aug. 6, 2026

(54) COMPOSTER

(71) Applicant: Lifetime Products, Inc., Clearfield, UT (US)

(72) Inventors: Drake Hinckley Allen, Salt Lake City, UT (US); Kent David Ashby, Logan, UT (US); Euan McArthur, Bountiful, UT (US)

(21) Appl. No.: 19/462,884

(22) Filed: Jan. 28, 2026

Related U.S. Application Data
(60) Provisional application No. 63/753,638, filed on Feb. 4, 2025.

(51) Int. Cl. C05F 17/964; C05F 17/907

(52) U.S. Cl. CPC C05F 17/964; C05F 17/907

(57) ABSTRACT

One example apparatus takes the form of a composter. One composter includes a drum which in turn includes a group of panels that are connectible to each other, and each of the panels has respective first and second portions connected to each other by a living hinge, a first drum wall and a second drum wall, both of which are connectible to respective ends of the panels, and when connected, the first drum wall and the second drum wall cooperate with the panels to define an interior of the drum, a stand, a first hub and a second hub, and the first and second hubs are connectible to the stand and to the first drum wall and the second drum wall, respectively, to rotatably support the drum on the stand, and a drum lock configured to releasably lock the drum in one or more different angular positions.

### TECHNOLOGICAL FIELD

One or more example embodiments are concerned with lawn and garden tools and equipment. One particular example embodiment comprises a composter that, with the exception of a small number of fasteners, may be made entirely of plastic. As disclosed herein, embodiments may comprise various other features as well.

### BACKGROUND

Conventional composters can include a large number of parts and may be difficult and complicated to assemble. Further, such composters typically employ metal fasteners and hardware, which tend to rust over time and may eventually fail. Also, conventional composters typically have a drum configuration that does not readily lend itself to packaging or shipping. This may be problematic since as shipping costs increase, there is economic pressure to reduce package sizing, and increase packaging efficiency.

### ASPECTS OF AN EXAMPLE EMBODIMENT

One or more example embodiments are concerned with lawn and garden tools and equipment. One particular example embodiment comprises a low-cost composter that may be made entirely of plastic. One example embodiment comprises a composter whose parts are configured to be easily and efficiently transported, such as in a shipping container. For example, the elements of the composter may be configured to be laid flat so that they can be easily stored and transported.

In one example embodiment, a composter comprises one or more panels, each including two, or more, segments connected to each other with one or more living hinges. The panels can be assembled together to form a drum of the composter. The panels may be connected to walls of the drum with plastic fasteners. The living hinge in a panel may enable that panel to be folded flat, or nearly so, so that one portion of the panel is stacked on top of the other portion of the panel.

With the possible exception of its stand, which may or may not include metal reinforcements, one embodiment of a composter may be largely devoid of any metal hardware and may, instead, be made entirely from plastic, such as HDPE (high density polyethylene) and/or polypropylene (PP) for example, including the fasteners used to assemble the pieces of the composter together. One example embodiment may include fewer than five metal fasteners. As such, an embodiment of a composter may include, for example, a plastic drum lock to selectively prevent/permit rotation of the drum, and may include plastic hubs to rotatably support the drum on the stand.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims or this disclosure in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of a composter is that the nearly exclusive use of plastic components, with only a small number of metal fasteners, may enable the composter to be produced at a relatively low cost. An embodiment may be configured so that it can be efficiently packaged and shipped in an unassembled form. An embodiment may eliminate rusting, and related concerns, typically associated with conventional composters that employ metal fasteners and/or metal hardware. Various other advantages of one or more embodiments will be apparent from this disclosure.

### BRIEF DESCRIPTION OF THE DRAWINGS

The appended drawings contain figures of example embodiments to further illustrate and clarify various aspects of one or more example embodiments. It will be appreciated that these drawings depict only example embodiments and are not intended to limit its scope. Aspects of various embodiments will be described and explained with additional specificity and detail through the use of the accompanying drawings in which:

FIG. 1 is a perspective view of a composter, according to one embodiment.

FIG. 2 is an outside perspective view of a panel, according to one embodiment.

FIG. 3 is an inside perspective view of a panel, according to one embodiment.

FIG. 4 is a cutaway view of a portion of a drum, comprising multiple panels connected together, according to one embodiment.

FIG. 5 is a detail view of the connection of two panels, according to one embodiment.

FIG. 6 is another detail view of the connection of two panels, according to one embodiment.

FIG. 7 is an inside perspective view of snap in fasteners, according to one embodiment.

FIG. 8 is an outside perspective view of snap in fasteners, according to one embodiment.

FIG. 9a is an exploded perspective view of a hub, according to one embodiment.

FIG. 9b is an assembled perspective view of the hub of FIG. 9a.

FIG. 10 is a side perspective view of a hub installed in a drum side wall, according to one embodiment.

FIG. 11 is an inside perspective view showing a hub installed in a drum side wall, according to one embodiment.

FIG. 12 is an outside perspective view showing a hub installed in a leg of a stand, according to one embodiment.

FIG. 13 is an outside perspective view of drum lock mechanism, according to one embodiment.

FIG. 14 is an outside perspective view of a drum lock mechanism configured and arranged to interface with a drum side wall, according to one embodiment.

FIG. 14a is a detail view of a slide of the drum lock mechanism of FIG. 14.

FIG. 15 is a perspective view of a stand that includes reinforcement elements, according to one embodiment.

FIG. 16 is a perspective view of elements of a stand that includes a support element, according to one embodiment.

FIG. 17 is a perspective view of a crosspiece of a stand that includes a complementary interlocking structure, according to one embodiment.

FIG. 18 is a perspective view of a leg of a stand that includes a complementary interlocking structure, according to one embodiment.

FIG. 18a is a detail view showing the connection of a crosspiece to a leg, using a fastener.

FIG. 19 is a perspective view of an example crosspiece, according to an embodiment.

### DETAILED DESCRIPTION OF SOME EXAMPLE EMBODIMENTS

One or more example embodiments comprise a composter that may be relatively low in cost. A composter may comprise plastic parts created using various processes such as injection molding, and blow-molding. Some elements of the composter, such as the drum for example, may be devoid of any metal fasteners and metal hardware. The composter may comprise various living hinges that enable elements of the composter to be manipulated in such a way, such as by folding for example, so that the composter can be efficiently packaged.

### A. General aspects of some example embodiments

In one or more embodiments, a composter and associated components disclosed herein, including, but not limited to, hubs, stands, legs, crosspieces, panels, drum side walls, drum lock mechanisms, fasteners, connector elements, supports, and other components, may be constructed with a variety of components and materials including, but not limited to, plastic (including injection-molded, plastic extrusion, blow-molded, roto-molded, and twin sheet plastic structures and elements) including polycarbonates, plastics such as high-density polyethylene (HDPE) polypropylene (PP), composites, fiberglass, wood, rubber, and combinations of any of the foregoing. One or more components of a composter may be created using a blow-molding, or other molding, process, examples of which are noted above, and below.

The scope of this disclosure is not limited to blow molding processes or blow molded components however. Thus, other example processes that may be used to construct a portion, or all, of any of the aforementioned components include roto-molding, injection molding, plastic extrusion, vacuum molding, drape molding, and processes sometimes referred to as twin-sheet processes including twin-sheet molding. Any of these processes may produce a component that is partly, or completely, hollow. As well, it will also be appreciated that components of the disclosed embodiments need not be constructed from plastic and may be constructed using other materials, which may be non-metallic, having suitable characteristics for the intended use(s) of a composter.

One embodiment of a composter, including fasteners, may consist entirely of plastic. An embodiment of a composter may, with the possible exception of metal supports in the stand, consist entirely of plastic. In an embodiment, only a small number of metal fasteners may be used, and any hardware of a composter may be plastic and/or other non-metallic material(s). In one particular embodiment, only two metal screws are used, in the stand.

As noted above, any component of an embodiment that is constructed at least partly of blow molded plastic may have an interior that is partly, or completely, hollow. Such embodiments may also include, disposed in their interior, one or more depressions, sometimes referred to as “tack-offs.” In such embodiments, these tack-offs may be integrally formed as part of a unitary, one-piece structure during the blow molding process. The depressions may extend from a first surface, such as a first interior surface of a component, towards a second surface, such as a second interior surface of the component. The ends of one or more depressions may contact or engage the second surface, or the ends of one or more of the depressions may be spaced apart from the second surface by a distance. Both types of depressions may be present in a single embodiment.

In some instances, one or more depressions on a first interior surface may be substantially aligned with corresponding depressions on a second interior surface, and one or more depressions on the first interior surface may contact one or more corresponding depressions on the second interior surface or, alternatively, one or more depressions on the first interior surface may be spaced apart from corresponding depressions on the second interior surface. In still other instances, depressions that contact each other, and depressions that are spaced apart from each other, may both be present in a component of one or more disclosed embodiments. The depressions may be sized and configured to strengthen and/or reinforce the component(s) in which they are present.

Some, no, or all, portions of a composter and its components may comprise surface treatments and/or textures. For example, any component of a composter may comprise a texture or pattern, which may be created with a blow-molding process, or other, process.

Finally, it is a characteristic of blow molded plastic structures, such as the disclosed examples of composter components, that they take the form of a unified, single piece structure that is formed by a single blow molding process. These structures are fully formed upon completion of the blow molding process and may, or may not, include one or more living hinges. By way of contrast, thermoformed and vacuum formed parts are typically constructed from multiple separate pieces which, after they are created, must then be attached together in some manner to create the final structure. Thus, the use of blow molding processes to create unified, single piece, structures may eliminate the need for post-formation assembly and attachment processes that are required in other processes.

In at least some instances, blow molded structures, such as example embodiments of the disclosed composter, may include one or more parting lines, that is, a small ridge or protrusion of plastic that is formed where the mold halves come together. Part of the parting line may be trimmed off post-production, but even after the trimming, visible vestigial portions may remain in the final structure, indicating where the mold halves came together during the molding process.

With continued reference to some example materials for one or more embodiments, suitable metals, such as for support elements, may include steel, aluminum, and aluminum alloys, although the skilled person will understand that a variety of other metals may be employed as well and the scope of this disclosure, and any claims, is not limited to the foregoing examples. Where metal is employed in the construction of a composter or composter component, the metal elements may take one or more forms including, but not limited to, square tube, rectangular tube, oval tube, round tube, pipe, angles, flat bar, I-shapes, T-shapes, L-shapes, and combinations and portions of any of the foregoing.

Depending upon the material(s) employed in the construction of composter components, a variety of methods and components may be used to connect, releasably or permanently, various elements of the composter. For example, the various elements of composters within the scope of this disclosure may be attached, permanently or removably, to each other by the use of complementary structures that may interface with each other, such as by interlocking with each other for example.

### B. Aspects of an example composter

### B.1 Overview

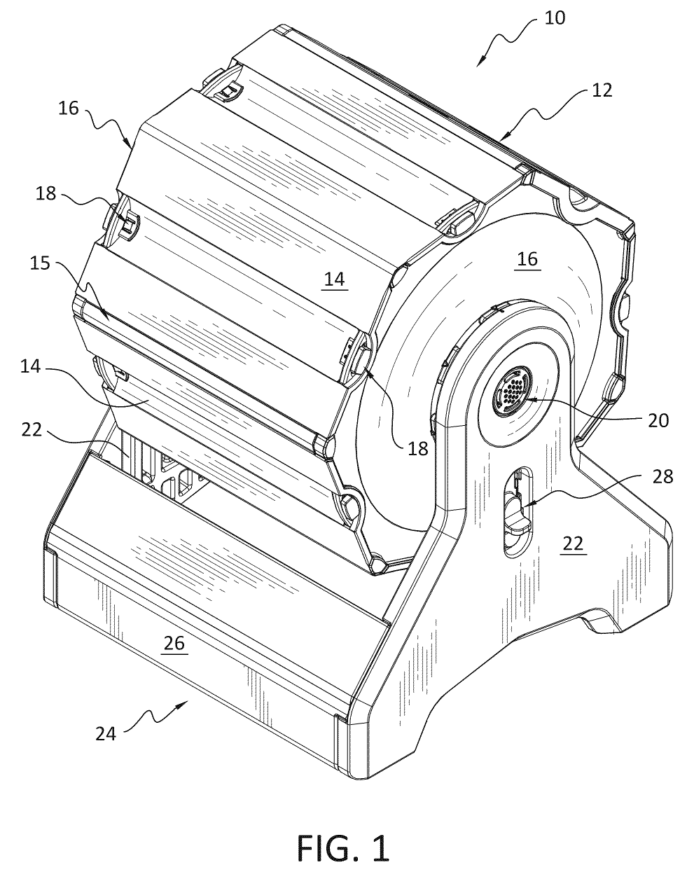

With reference first to FIG. 1, an example composter 10 according to one embodiment is disclosed. By way of brief overview, the composter 10 may comprise a drum 12 that comprises multiple panels 14 connected to each other at respective edges with connectors 15. The drum 12 may be enclosed at each side by a drum side wall 16. The panels 14 may be attached to the drum side walls 16 by fasteners 18. The drum 12 may be rotatably supported by two hubs 20 carried by respective legs 22 of a stand 24. A drum lock 28 may be used to releasably lock the drum 12 into a particular angular position with respect to an axis passing through the two hubs 20.

### B.2 Panels and connectors

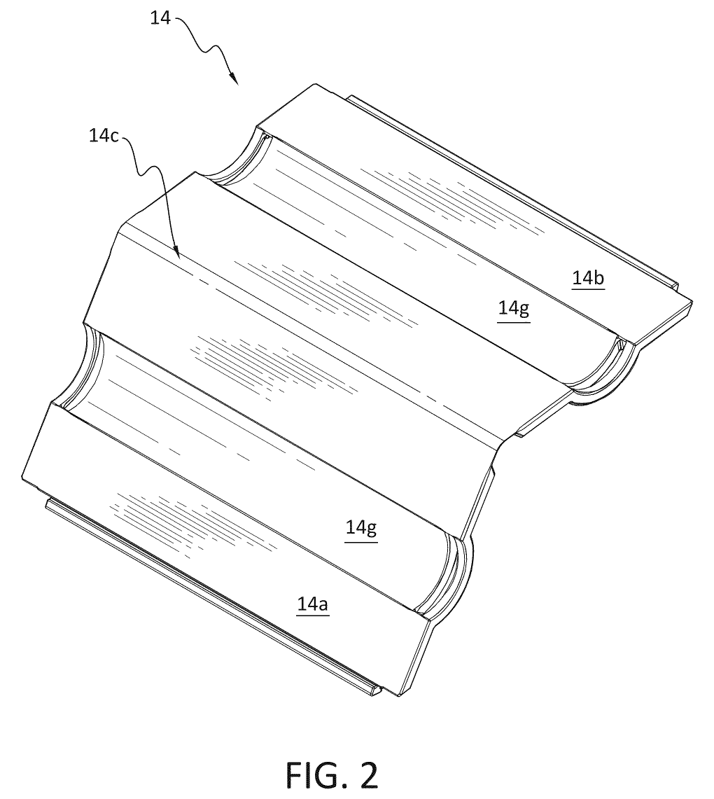

With attention now to FIGS. 2, 3 and 4, aspects of the panel 14 according to one embodiment are disclosed. As shown, the panel 14, which may have a unified, single-piece, construction such as may obtained with a blow-molding process or other molding process, may comprise various portions, such as the portions 14a and 14b, that are connected to each other by way of a living hinge 14c. Among other things, the living hinge 14c may enable the portion 14a and/or portion 14b to be rotated about the living hinge 14c so that the portions 14a and 14b can be stacked flat, or nearly so, one on top of the other. This stacked configuration of the panel 14 may enable the panel 14 to be compactly configured for packaging and shipping.

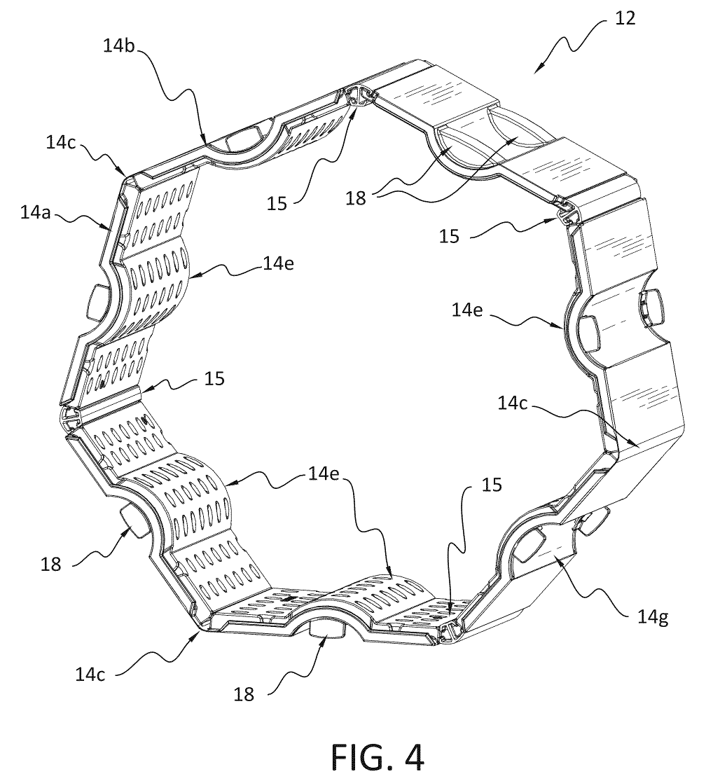

While the example panel 14 shown in the Figures includes only a single living hinge 14c, it should be understood that another embodiment of a panel may include two, or more, living hinges connecting various portions that may be configured similarly, or identically, to the portions 14a and/or 14b. As shown in the particular, but non-limiting, example of FIG. 4, the drum 12 comprises a total of three living hinges 14c.

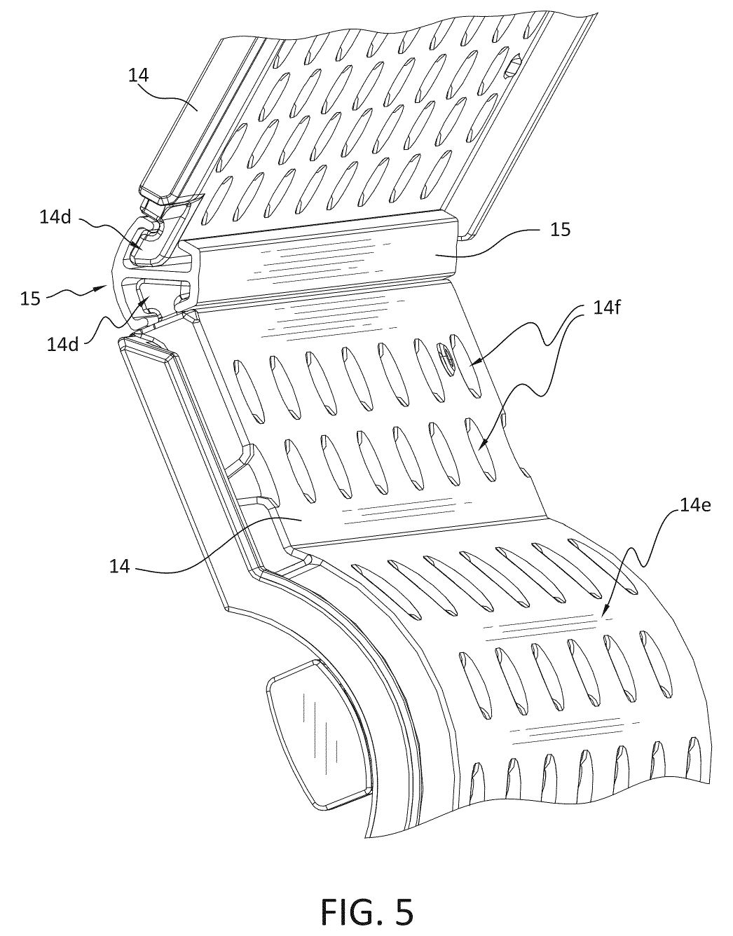

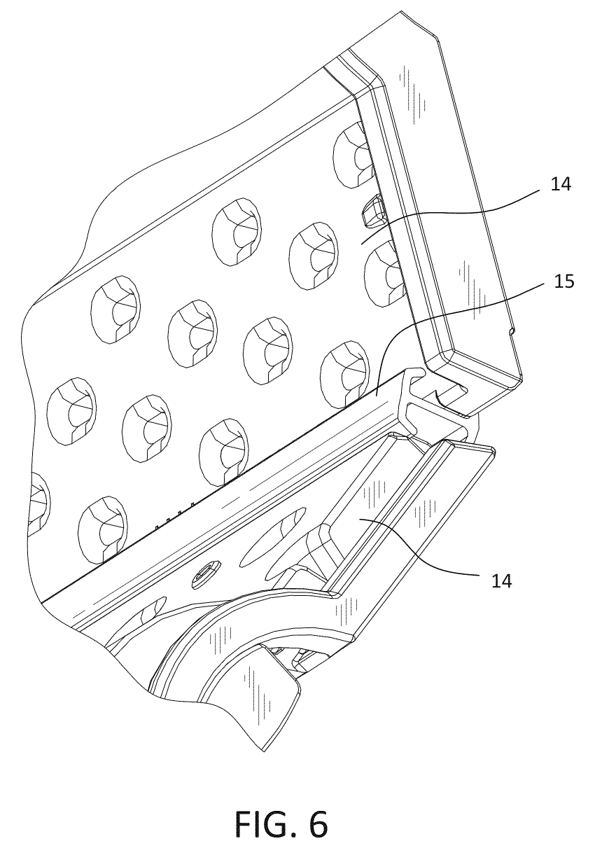

In addition to the living hinges 14c, and with reference now to the examples of FIG. 5 and FIG. 6 as well, an embodiment of the drum 12 may comprise connectors 15, which may be made of plastic, configured to engage respective edges of adjacent panels 14 so as to connect the adjacent panels 14 to each other. In an embodiment, the connectors 15 may comprise a generally T-shaped cross-section that is configured to engage correspondingly configured connection elements 14d of the panels 14. In an embodiment, a connector 15 may be brought into engagement with, and disconnected from, the connection elements 14d by sliding one, or both, of the connector 15 and connection element 14d relative to the other. It is noted that the connector 15/connection element 14d configurations are presented only by way of example, and any other configuration that employs respectively complementary structures of a connector 15 and panel 14 to connect, possibly releasably, two or more panels 14 together may be employed in other embodiments. Advantageously, the use of connectors 15 may eliminate the need to employ fasteners to connect the panels 14 to each other.

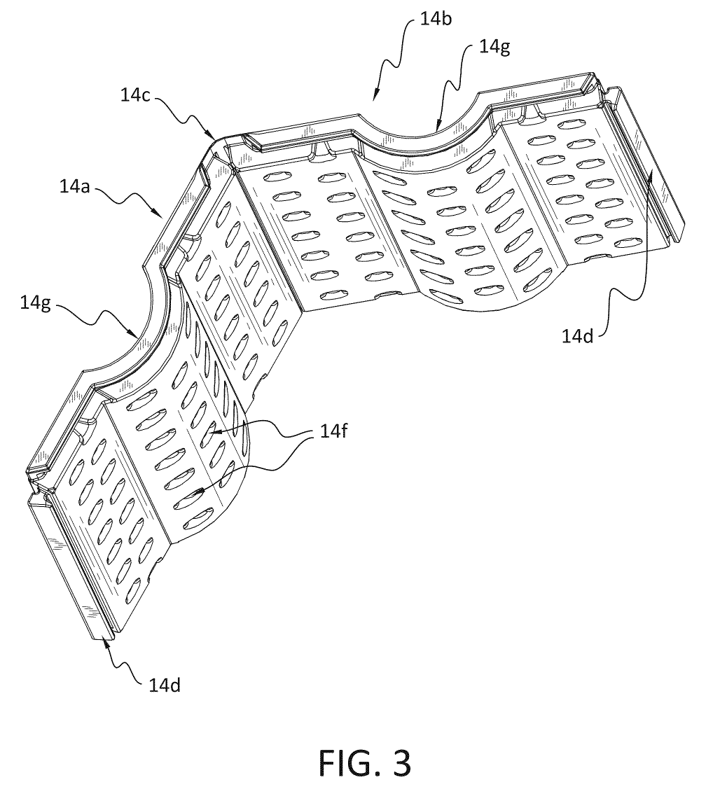

With reference again to FIGS. 2 through 5, an embodiment of a panel 14 may include one or more convex portions 14e that bulge inward toward the interior of the drum 12. This configuration may help to prevent materials from sticking to the interior of the drum 12, and may help to ensure that the material in the drum 12 is churned as the drum 12 is rotated by a user, and one or more tack-offs 14f may also be useful in these respects. As also shown in FIGS. 3-5, the non-protruding portions of the interior of a panel 14 may likewise comprise tack-offs 14f.

### B.3 Fasteners

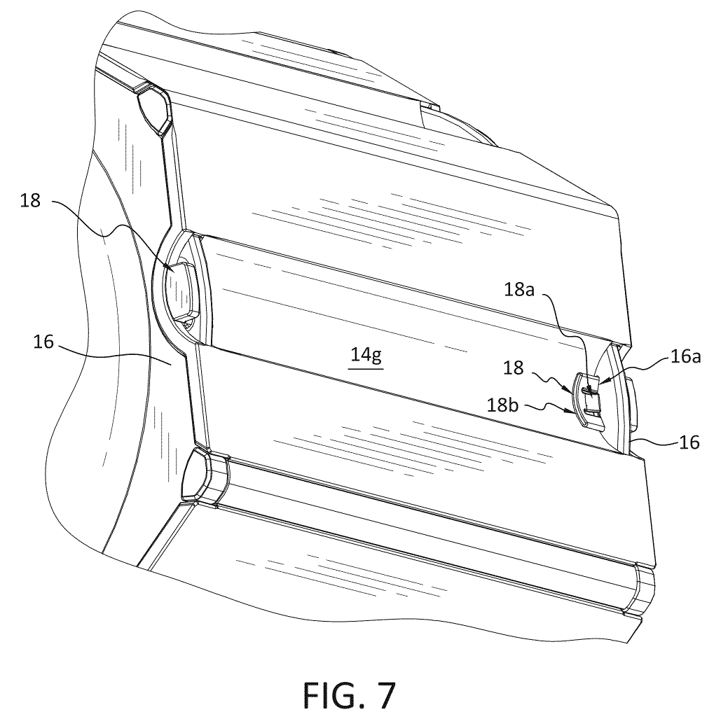

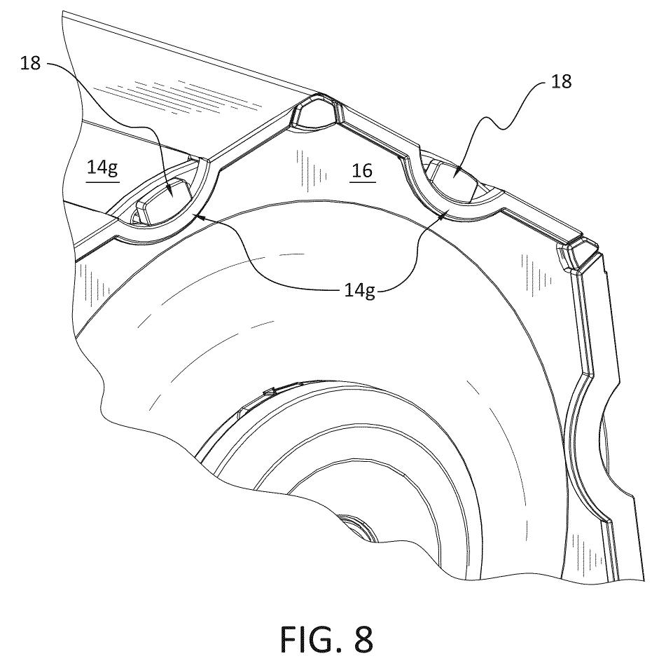

With continued reference to the examples of FIGS. 2-4, and directing attention now to FIG. 7 as well, an example panel 14 may comprise one or more concave portions 14g disposed opposite respective convex portions 14e. As shown in FIGS. 7 and 8, the concave portions 14g may, by providing an accommodating space, enable the use of the fasteners 18 to connect the drum 12 to the drum side walls 16. In an embodiment, the fasteners 18 comprise a configuration that may conform to the curvature of the concave portion 14g. The fasteners 18 may comprise a tab 18a that is biased away from a main body 18b of the fastener so that as the tab 18a is inserted through an opening 16a defined by the drum side wall 16, the tab 18a is elastically depressed and passes through the opening 16a. After passing through the opening 16a, the tab 18a returns to its biased position, such that the tab 18a is able to prevent the fastener 18 from being withdrawn from the opening 16a unless, or until, the tab 18a is depressed again so that it can pass through the opening 16a. In this way, the fasteners 18 may releasably connect the drum 12 to the drum side walls 16. Moreover, the drum 12 can be attached in this way to the drum side walls 16 without the use of any hardware, or metal fasteners.

### B.4 Hub

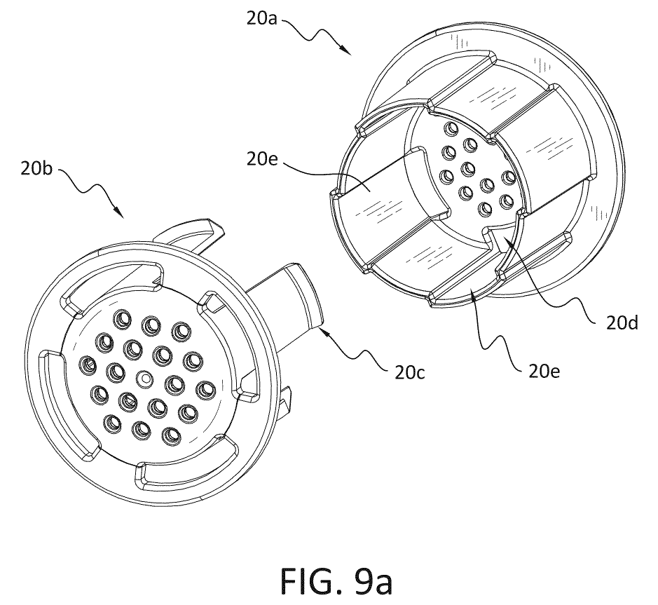

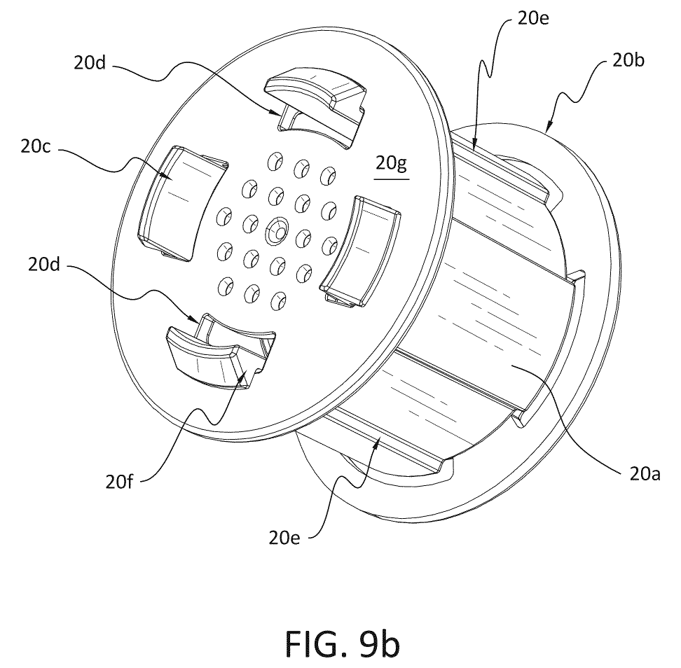

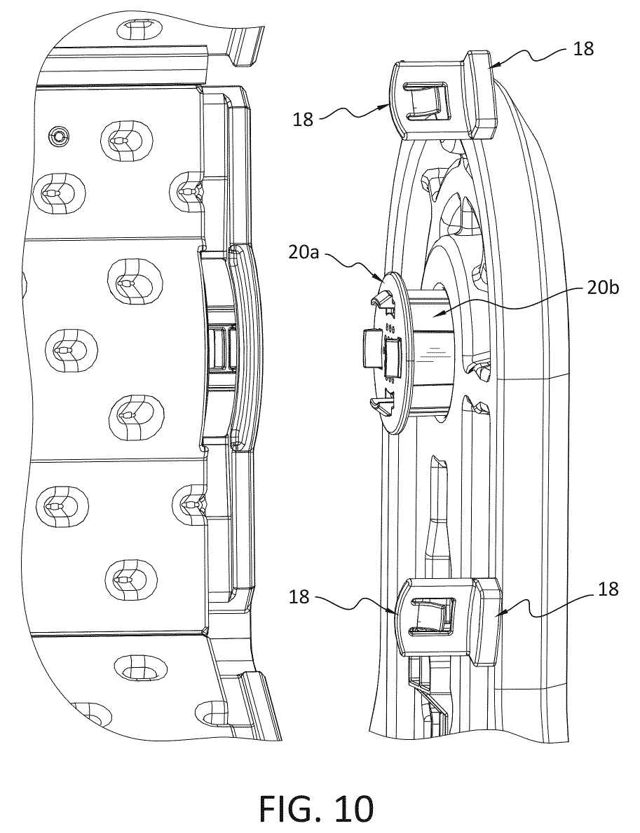

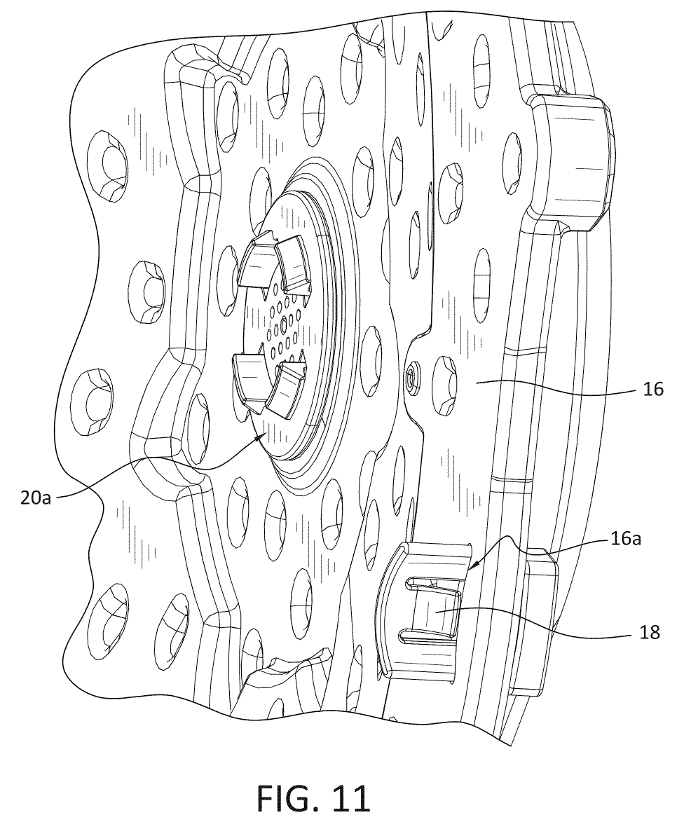

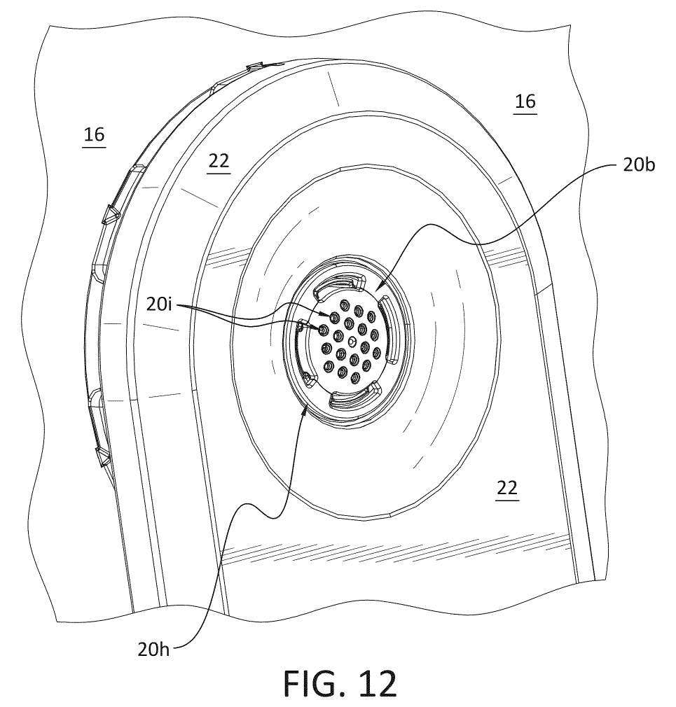

With reference now to the examples of FIGS. 9a, 9b, 10, 11, and 12, an embodiment of a composter 10 may comprise two hubs 20 disposed on respective opposing sides of the drum 12. The hubs 20 may serve to rotatably support the drum 12 on the stand 24. As in the case of all the other components of the composter 10, with any exceptions as noted, the hubs 20 may have an all-plastic construction.

The example hub 20 may comprise an insert 20a and a locking portion 20b that is configured to engage the insert 20a in such a way that the two elements cannot be easily separated from each other. In particular, the locking portion 20b may comprise one or more bendable tabs 20c configured to pass through respective openings 20d defined in the insert 20a.

In an embodiment, the tabs 20c, which may be biased radially outward, may each be inserted into, and pushed along, a respective passage 20e that is defined in the insert 20a and that terminates in one of the openings 20d. As shown in FIG. 9b, when the locking portion 20b is fully received within the insert 20a, the tab 20c extends from the opening 20d and an L-shaped terminal portion 20f may move radially outward, under the influence of the bias, so that the terminal portion 20f engages a top surface 20g of the insert 20a, thus preventing retraction of the locking portion 20b from the insert 20a unless, or until, the tabs 20c are pressed radially inward to clear the top surface 20g.

With continued reference to FIGS. 9a through 12, the locking portion 20b may be configured to pass through the leg 22 and into the interior of the drum 12. The locking portion 20b may include a flange 20h that prevents the locking portion 20b from being pushed all the way through the leg 22 and into the drum 12. In an embodiment, the flange 20h may include aeration holes 20i to enable air flow through the interior of the drum 12.

### B.5 Drum lock

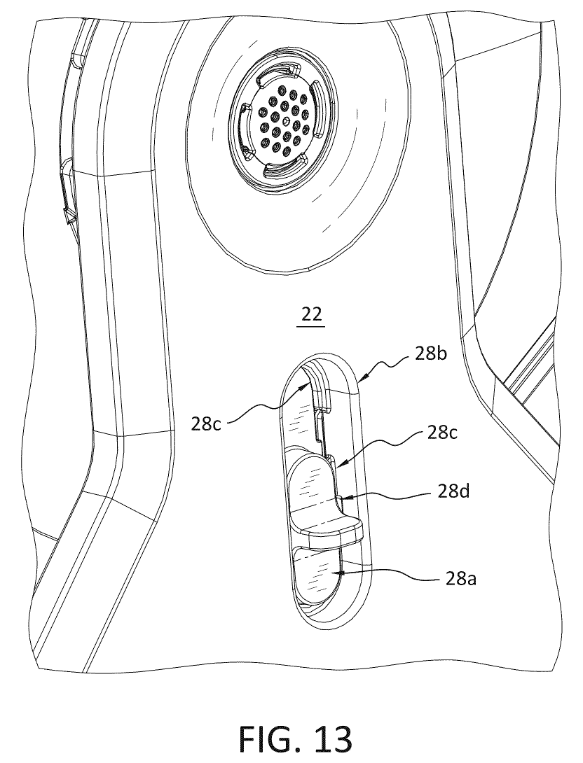

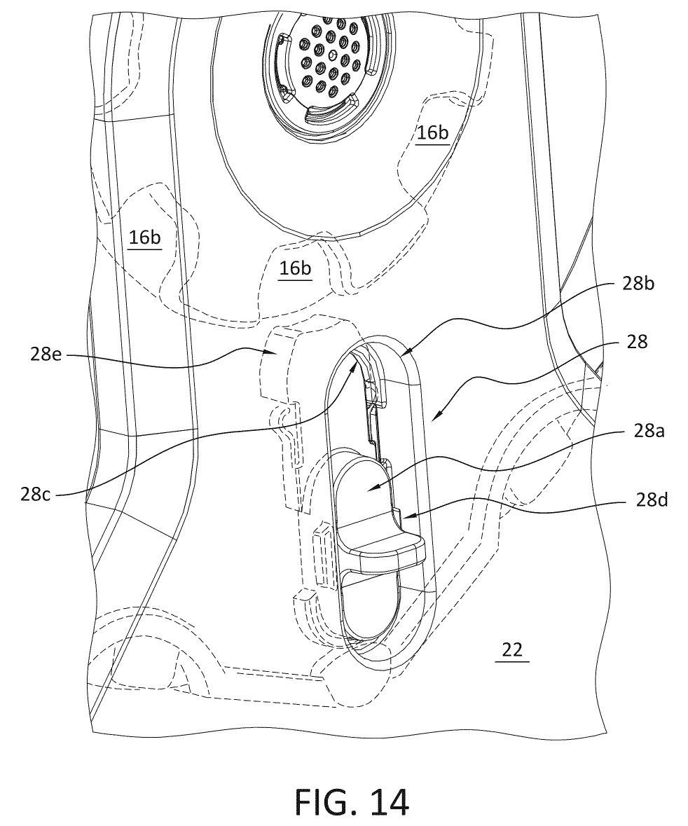

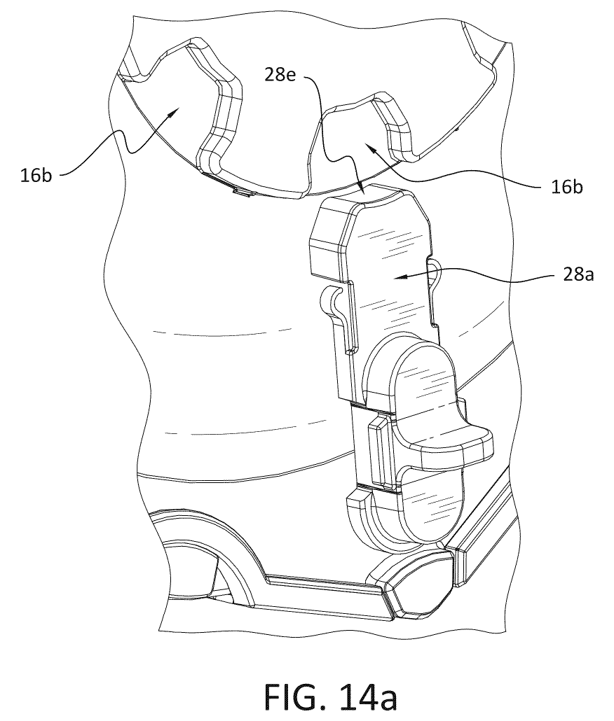

As shown in the examples of FIGS. 13, 14, and 14a, an embodiment may comprise one or more drum locks 28. In an embodiment, a drum lock 28 may be provided on each side of the drum 12. Alternatively, an embodiment may have only a single drum lock 28. In general, an embodiment of a drum lock enables the drum 12 to be releasably locked in a desired angular position.

In the example of FIGS. 14 and 14a, the drum lock 28 comprises a slide 28a configured to move back and forth in a track 28b defined in the leg 22. The track 28b may comprise one or more guides 28c that prevent the slide 28a from lifting out of the track 28b. Similarly, the slide 28a may comprise one or more guides 28d that prevent the slide 28 from falling through the track 28a.

The slide 28a may comprise a terminal portion 28e sized, configured, and arranged, to releasably engage one or more corresponding recesses 16b defined in the drum side wall 16. When the slide 28a is so engaged with the drum 12, rotary movement of the drum 12 is prevented. As shown in FIGS. 14 and 14a, multiple recesses 16b may be provided in an embodiment, each corresponding to a different respective angular position of the drum 12. In an embodiment, the slide 28a may be biased, such as by way of a spring for example, into engagement with a recess 16b. In another embodiment, the biasing element may be omitted, and the slide 28a may remain in a desired position due to friction between the slide 28a and the leg 22.

### B.6 Stand

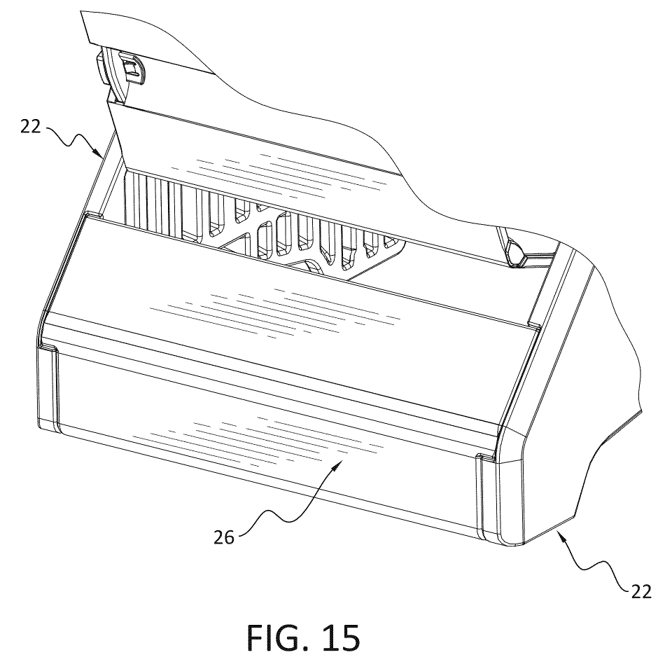

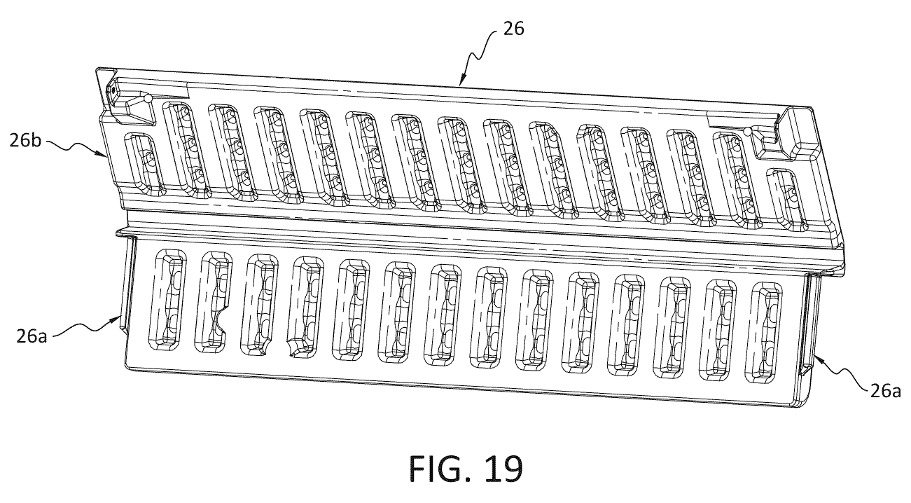

With reference now to FIGS. 15-19, further details are provided concerning an embodiment of a stand 24 that may be included as an element of a composter 10. As noted earlier, an embodiment of the stand 24 may comprise two legs 22 releasably connected to each other by a cross piece 26. When placed on a surface, the stand 24 locates the hub 20 sufficiently high that the drum 12 does not contact the surface.

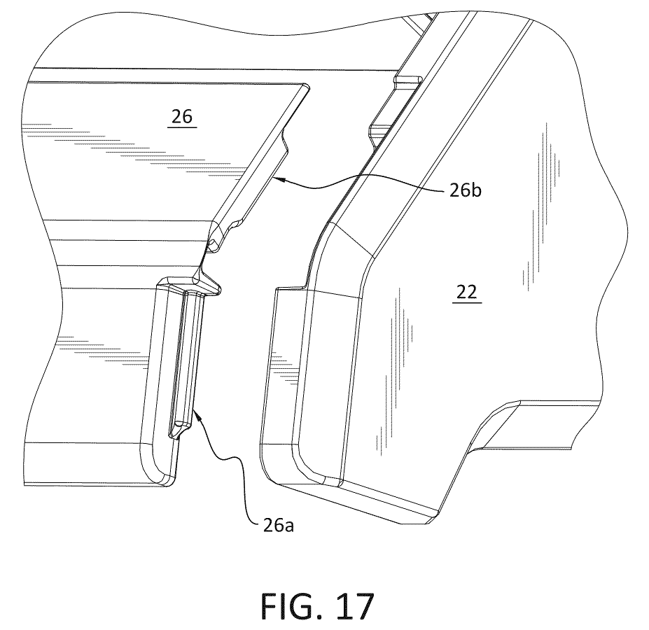

The cross piece 26, which may comprise a blow-molded element that has an integral, single-piece, construction, may comprise first complementary structures 26a and 26b configured to engage respective complementary structures 22a and 22b of the legs 22. As shown in FIGS. 17-19, the first complementary structures 26a and 26b may comprise respective protrusions, and second complementary structures 22a may each comprise a channel configured to receive, possibly removably, the protrusion, while the second complementary structures 22b may comprise recesses configured to receive the first complementary structures 26b.

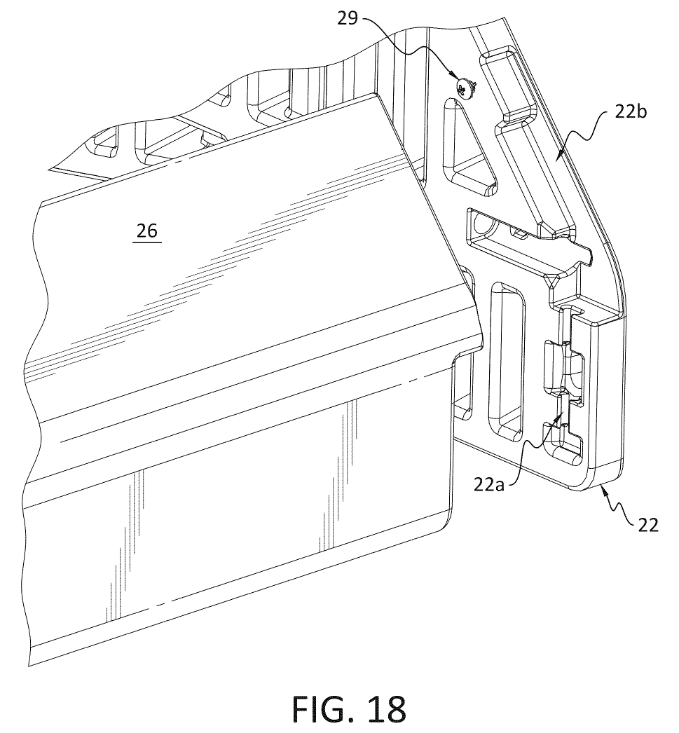

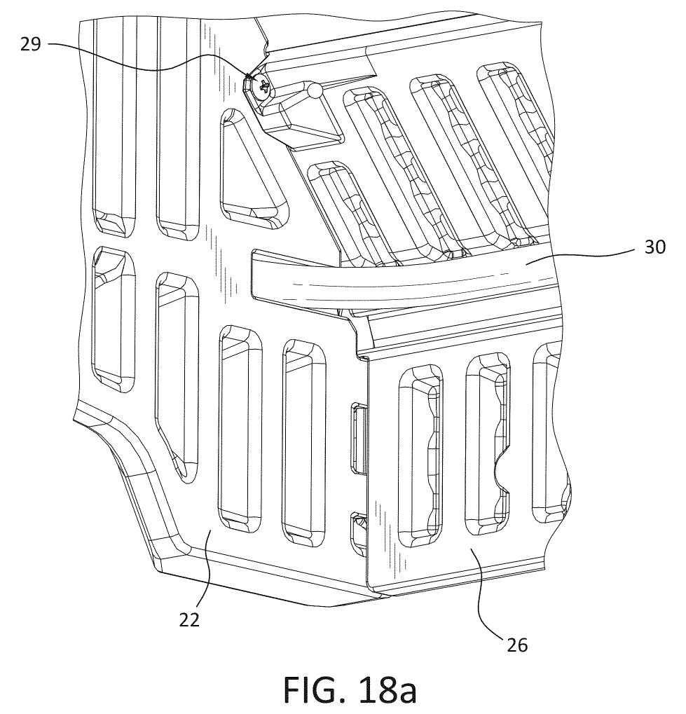

In an embodiment, the legs 22 can be connected to the cross piece 26 by positioning the protrusions at the ends of the cross piece 26 above the channels defined by the legs 22, and then pushing the cross piece 26 down until each of the protrusions reaches the bottom of a respective channel of one of the legs 22. Additionally, the crosspiece 26 may be secured at each end to the legs 22 with fasteners 29, such as screws for example, as shown in FIGS. 18 and 18a.

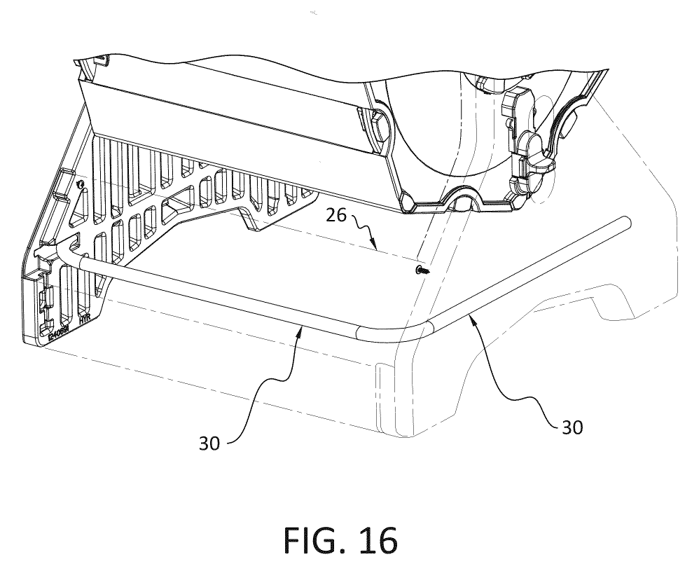

With continued attention to FIG. 16 in particular, an embodiment may comprise one or more supports 30 which may be configured to be positioned partly or completely within the interior of one or more plastic elements, such as the legs 22 and the cross piece 26, so as to provide strength, stability, and support to the stand 24, while reducing the likelihood of rusting. In an embodiment, the supports 30 may not be entirely disposed within the interior of one or more plastic elements, but a majority of the length of the supports 30 may be disposed within the interior of one or more plastic elements. In an embodiment, the supports 30 may comprise tubing, or solid pieces, which may be made of a non-rusting metal such as aluminum for example. In an embodiment, the supports 30 may comprise steel, or a steel alloy. In an embodiment, the supports 30 may comprise one or more non-metallic materials, such as plastic or composites for example. In an embodiment, the supports 30 may be omitted.

### B.7 Further discussion

As disclosed herein, one or more embodiments may possess various useful features and aspects, although no embodiment is required to possess any of such features or aspects. The following examples are illustrative of such features and aspects, but not exhaustive.

An embodiment may comprise all plastic fasteners, such as snap in fasteners, to secure one or more panels to a drum side wall without requiring any metal hardware. Such fasteners may facilitate easy assembly of an embodiment, while also reducing costs due to elimination of fasteners, and avoiding rust by omitting the use of metal hardware.

An embodiment may comprise a two piece, plastic, snap-in hub that includes aeration holes. By constructing the hub from plastic, the possibility of rust is eliminated. As well, the configuration of the hub may prevent compost from spilling out of the drum, while also providing a substantial structure for rotational support of the drum.

An embodiment may comprise a plastic drum lock that includes a slide configured for selective engagement of the drum so as to prevent, and permit, rotation of the drum, as needed. The all-plastic construction of an embodiment of the drum lock prevents rust that would otherwise likely occur if the drum lock included one or more metal parts.

An embodiment may comprise one or more panels that include two or more portions connected to each other by a living hinge. Use of the living hinge(s) enables assembly of multiple panels into a generally circular, or polygonal, drum. As well, the living hinges of an embodiment may enable the panels to be compactly configured for packaging and shipping.

Finally, an embodiment may include a plastic stand that may, or may not, include a metal insert that may reside partly, or completely, within the plastic structure of the stand so as to provide strength to the stand while reducing, or eliminating, the possibility of rust. The stand may be configured so that its elements can slide and/or snap together for easy assembly.

### C. Further example embodiments

Following are some further example embodiments. These are not intended to limit the scope of this disclosure, or of any claims, in any way.

Embodiment 1. A composter, comprising: a drum, comprising: a group of panels that are connectible to each other, and each of the panels comprises respective first and second portions connected to each other by a living hinge; and a first drum wall and a second drum wall, both of which are connectible to respective ends of the panels, and when connected, the first drum wall and the second drum wall cooperate with the panels to define an interior of the drum; a stand; a first hub and a second hub that are connectible to the stand and to the first drum wall and the second drum wall, respectively, to rotatably support the drum on the stand; and a drum lock configured to releasably lock the drum in one or more different angular positions.

Embodiment 2. The composter as recited in any preceding embodiment, wherein the composter is largely devoid of metal fasteners and metal hardware, and may contain only a small number of metal fasteners.

Embodiment 3. The composter as recited in any preceding embodiment, wherein the composter is composed entirely of plastic.

Embodiment 4. The composter as recited in any preceding embodiment, further comprising snap in fasteners configured to connect the first drum wall and the second drum wall to the panels.

Embodiment 5. The composter as recited in any preceding embodiment, wherein the stand comprises two legs, and a crosspiece that is connectible to the legs.

Embodiment 6. The composter as recited in any preceding embodiment, wherein each of the hubs comprises an insert and a locking portion, and the insert is configured to be received in an opening in the stand and includes a flange at one end which, when the insert is so received, is positioned in the interior of the drum, and the locking portion is configured to lock together with the insert and the locking portion includes a flange at one end that is located at an exterior of the drum when the insert is positioned in the stand and the locking portion is locked together with the insert.

Embodiment 7. The composter as recited in any preceding embodiment, wherein the hubs each comprise aeration holes that communicate with the interior of the drum when the hub is connected to the drum.

Embodiment 8. The composter as recited in any preceding embodiment, wherein the drum lock comprises a slide that is movable into, and out of, engagement with recesses defined in the first drum wall, and when the slide is engaged with one of the recesses, rotation of the drum is prevented.

Embodiment 9. The composter as recited in any preceding embodiment, wherein each of the panels is a unitary, single piece, structure.

Embodiment 10. The composter as recited in any preceding embodiment, further comprising a metal support partly disposed within an interior of the stand.

Embodiment 11. The composter as recited in any preceding embodiment, wherein the panels are foldable about an axis defined by the living hinge so that the first portion and the second portion form a stacked configuration.

The described embodiments are to be considered in all respects only as illustrative and not restrictive. All changes which come within the meaning and range of equivalency of the claims are to be embraced within their scope.

What is claimed is:

1. A composter, comprising:
a drum, comprising:
a group of panels that are connectible to each other, and each of the panels comprises respective first and second portions connected to each other by a living hinge; and
a first drum wall and a second drum wall, both of which are connectible to respective ends of the panels, and when connected, the first drum wall and the second drum wall cooperate with the panels to define an interior of the drum;
a stand;
a first hub and a second hub that are connectible to the stand and to the first drum wall and the second drum wall, respectively, to rotatably support the drum on the stand; and
a drum lock configured to releasably lock the drum in one or more different angular positions.

2. The composter as recited in claim 1, wherein the drum is devoid of metal fasteners and metal hardware.

3. The composter as recited in claim 1, wherein the composter is composed entirely of plastic.

4. The composter as recited in claim 1, further comprising snap in fasteners configured to connect the first drum wall and the second drum wall to the panels.

5. The composter as recited in claim 1, wherein the stand comprises two legs, and a crosspiece that is connectible to the legs.

6. The composter as recited in claim 1, wherein each of the hubs comprises an insert and a locking portion, and the insert is configured to be received in an opening in the stand and includes a flange at one end which, when the insert is so received, is positioned in the interior of the drum, and the locking portion is configured to lock together with the insert and the locking portion includes a flange at one end that is located at an exterior of the drum when the insert is positioned in the stand and the locking portion is locked together with the insert.

7. The composter as recited in claim 1, wherein the hubs each comprise aeration holes that communicate with the interior of the drum when the hub is connected to the drum.

8. The composter as recited in claim 1, wherein the drum lock comprises a slide that is movable into, and out of, engagement with recesses defined in the first drum wall, and when the slide is engaged with one of the recesses, rotation of the drum is prevented.

9. The composter as recited in claim 1, wherein each of the panels is a unitary, single piece, structure.

10. The composter as recited in claim 1, further comprising a metal support partly disposed within an interior of the stand.

11. The composter as recited in claim 1, wherein the panels are foldable about an axis defined by the living hinge so that the first portion and the second portion form a stacked configuration.

12. A composter kit including an unassembled composter, comprising:
a group of panels that are releasably connectible to each other to form a portion of a drum, and each of the panels comprises respective first and second portions connected to each other by a living hinge, and the living hinge enables the first and second portions to be stacked one on top of the other; and
a first drum wall and a second drum wall, both of which are configured to be attached to respective ends of the panels to cooperate with the panels to define an interior of the drum;
a stand;
a first hub and a second hub that are connectible to the stand and to the first drum wall and the second drum wall; and
a drum lock carried by the stand.

13. The composter kit as recited in claim 12, wherein the unassembled composter has an all-plastic construction.

14. The composter kit as recited in claim 12, further comprising plastic connectors configured to connect the panels together.

15. The composter kit as recited in claim 12, wherein except for the stand, the unassembled composter is devoid of metal fasteners.
